(19) United States
(12) Patent Application Publication
(10) Pub. No.: US 2010/0094677 A1
(43) Pub. Date: Apr. 15, 2010

(54) PRIORITIZING PROBLEMS IN IT SERVICES

(76) Inventors: Christopher Peltz, Windsor, CO (US); David Trastour, Bristol (GB); Claudio Bartolini, Menlo Park, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/251,259

(22) Filed: Oct. 14, 2008

(51) Int. Cl. G06Q 10/00

(52) U.S. Cl. 705/8

(57) ABSTRACT

In an embodiment, the invention provides a method of prioritizing problems in IT services. The method comprises determining a plurality of N problems. An incident cost, a workaround cost, an expected resolution cost, and a total cost for each of the N problems is determined. A priority is assigned to each of the N problems such that each priority has an expected resolution time. The priorities are assigned such that the total cost for fixing all N problems is lower than any other selection of priorities.

### BACKGROUND

IT (Information Technology) services are provided by a collection of hardware components, software components and people. When one of these components experience a problem (e.g. hardware fault, configuration error, software conflict etc.), one or several IT services may be affected. A symptom of such an IT problem is usually a drop in service level (availability or performance). In organisations that have implemented a ITIL (Information Technology Infrastructure Library) processes, a service disruption is usually reported to an IT help desk that will raise an incident ticket.

As part of an incident management process, the incident ticket is logged, categorized and prioritized. The incident ticket is then investigated, diagnosed and resolved. When the IT service has recovered, the incident can be closed. During this process, the incident is passed from a help desk through to various support groups.

During investigation and diagnosis phases, IT support may discover that an incident is the symptom of an underlying IT problem. A problem management process is responsible for maintaining a knowledge base of such problems, to document the problems, and when possible, to develop a workaround for them. Workarounds do not provide a expected resolution to a problem but allow the symptoms of a problem to be mitigated and the IT service to be restored (e.g. rebooting an application that has a memory leak is a workaround).

In IT outsourcing scenarios, service level agreements (SLAS) define acceptable service levels to a customer organization. Moreover, it is common that support SLAs are also put into place to regulate turnaround times of incidents depending on their perceived impact and severity. Depending on the terms and conditions dictated by the SLAs and the urgency of the incidents, an IT service provider organization may not be afforded the time to satisfactorily diagnose and close a problem. As a result the IT service provider organization may be forced to deploy workarounds to mitigate the symptoms of the problem.

Implementing workarounds come at a cost. In addition to an operator's time spent on the problem, a workaround may (1) not guarantee an optimal service level, possibly impacting performance applications (e.g. temporary migration of applications to a secondary application server), (2) require taking systems offline, possibly impacting availability of SLAs, and (3) being viable for a certain period of time, impacting support SLAs (e.g. periodically, during pre-agreed maintenance windows, rebooting of systems to address memory leaks that build up and threaten to impact performance).

### BRIEF DESCRIPTION OF THE DRAWINGS

FIG. 1 is a timeline of an exemplary embodiment of a method of prioritizing problems in IT services.

FIG. 2 is a flow chart of an exemplary embodiment of a method of prioritizing problems in IT services.

### DETAILED DESCRIPTION

The drawings and description, in general, disclose a method and apparatus of prioritizing problems in IT services. In one exemplary embodiment, a plurality of N problems may be assigned a priority p from a plurality of priorities P. Each priority p has a defined expected resolution time dₚ for solving a problem. The cost of resolving the problems N during a defined expected resolution time dₚ for a given priority p may be calculated using an incident cost, Iₙ, a workaround cost Wₙ, a number V_{n,p} of occurrences of each N problems for each priority p and an expected resolution cost C_{n,p} for fixing each of the N problems.

After all costs have been calculated, a minimum total cost Cₜ for solving all N problems may be determined by selecting a priority p from the plurality of P priorities for each of the N problems such that a total cost Cₜ for fixing all N problems is lower than any other selection of priorities p from the plurality of P priorities for each of the N problems. In one exemplary embodiment, the cost R_{n,p} of fixing each of the N problems is proportional to:

V_{n,p}*(Iₙ+Wₙ)+C_{n,p}

In an another exemplary embodiment, a plurality of priorities P may vary from 1 (very urgent) to P (less urgent). In this exemplary embodiment, a decision process consists of assigning a priority p to each problem N that exists in IT services. Expected resolution times dₚ for each priority p may be assigned. For example, for 4 priorities (i.e. P=4) the expected resolution times dₚ are shown in Table 1 below.

TABLE 1

| Priority p | Expected resolution time dₚ |
|---|---|
| 1 | In 3 days from incident creation |
| 2 | In 1 week from incident creation |
| 3 | In 2 weeks from incident creation |
| 4 | In 1 month from incident creation |

In order to prioritize the N problems, the costs for solving and not solving the N problems must be understood. In this exemplary embodiment, costs may be better understood by following these steps: (1) assess the cost of a recurring problem in terms of its impact on service levels and incidents that it causes, (2) assess the cost of implementing available workarounds, and the effect that these would have on the service levels (and consequently incidents), and (3) estimate the effort and time necessary for solving the problem.

Problems may be documented in a problem data base. Each problem may be described in this database along with a workaround that can temporarily mitigate the effect of the problem. An example of a problem is a memory leak for an application, and a workaround, for example, may be to restart the application. While problems exist in IT services, a problem may continue to generate incidents Iₙ. In the example of the memory leak, a memory leak may continue to cause incidents Iₙ which over time may slow down an application. As the application slows down, more calls will likely be made to a help desk.

The number of times an incident Iₙ occurs during a priority p with an expected resolution time dₚ is expressed as V_{n,p}. The number of times the incident Iₙ occurs depends on a particular problem and the priority p the problem is assigned. For example, if a priority p has a short expected resolution time, the number of times an incident Iₙ occurs may be lower than a priority with a longer expected resolution time. The number of times an incident occurs may, for example, be determined from historical data for the incident or based on knowledge from a support staff.

In one exemplary embodiment, the incident cost for problems is V_{n,p}*Iₙ. In another exemplary embodiment, the incident cost may correspond to the penalties defined in the SLA for the SLOs (service level objectives) that are violated. In another embodiment the incident cost may be the business impact caused by the incident. For example, if an e-commerce application has a memory leak and its performance becomes unacceptable, customers may not make purchases, and the incident cost corresponds to a loss of business.

To mitigate the effects of incidents, IT support technicians may implement workarounds. W_{p,n} denotes the cost of a workaround for a problem n if put in priority p. An average cost of a workaround for a problem n is denoted by Wₙ. In this embodiment, Wₙ includes the direct cost of implementing the workaround (people and equipment) as well as any potential business impact. For example, to mitigate the effect of a memory leak, one may restart the application which may cause the application to be unavailable for a period of time. This reboot may incur SLA penalties and/or some loss of business. In one embodiment, W_{n,p} is calculated using the average cost of a workaround (i.e. W_{n,p}=V_{p,n}*Wₙ). In another embodiment, sophisticated forecasting techniques may be used to estimate the cost of applying workarounds.

Until a problem is corrected, incidents Iₙ will occur and workarounds Wₙ may need to be performed. Correcting the underlying problem typically requires human and technical resources. For example, an estimated expected resolution cost C_{n,p} may include the cost of 2 days of work from a software engineer to write software changes, the cost of 2 days of work from a test engineer for quality assurance, and the cost of one day of work from a support engineer to release the change into production.

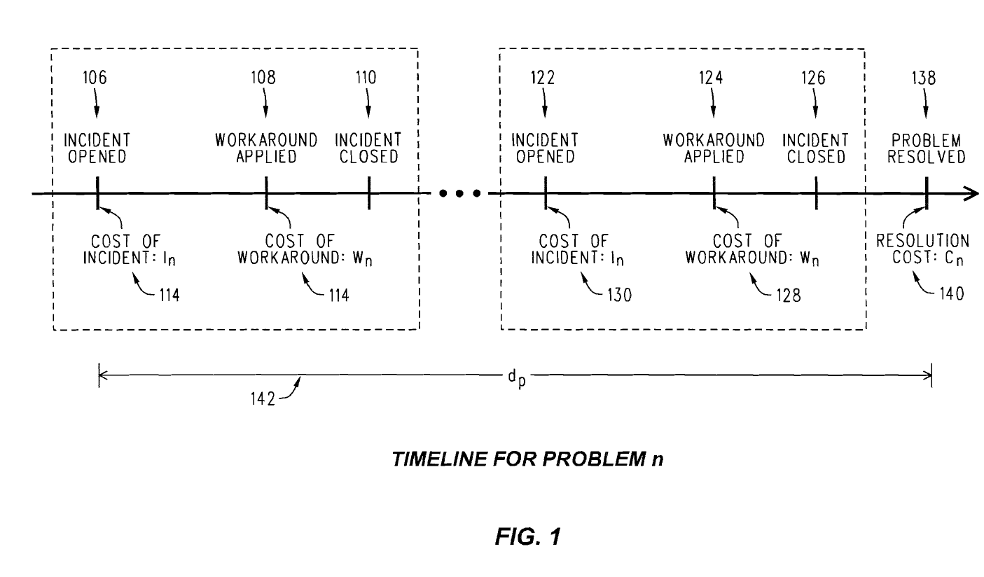

The expected resolution cost C_{n,p} is an estimated cost of fixing a problem n within an expected resolution time dₚ. FIG. 1 is a timeline of an exemplary lifecycle of a problem n. Average valves of incident cost Iₙ and workaround cost Wₙ are used in this example along with expected resolution time dₚ.

In FIG. 1 the first incidence 106 of problem n is shown in block 102. In block 102 the first incidence 106 of the problem n is opened. 20Next a workaround 108 is applied. Finally, in block 102, the first incidence 110 is closed. The cost 114 of the first incident is Iₙ and the cost 112 of the workaround is Wₙ. The total cost of the first incidence of problem n in this example is Iₙ plus Wₙ. Second and third incidences occur in this example but are not shown.

In FIG. 1 the fourth incidence of problem n is shown in block 104. In block 104, the fourth incidence 122 of the problem n is opened. Next a workaround 124 is applied. Finally, in block 104, the forth incidence 126 is closed. The cost 130 of the fourth incident is Iₙ and the cost 128 of the workaround is Wₙ. The total cost of the fourth incidence of problem n in this example is Iₙ plus Wₙ.

In FIG. 1 the expected resolution time dₚ of problem n is indicated by 142. At this time, the problem n is resolved. The cost Cₙ of resolving problem n is indicated by 140. The total cost of resolving problem n in this example is:

4*(Iₙ+Wₙ)+Cₙ

In another exemplary embodiment, incident costs Iₙ and workaround costs Wₙ are given in Table 2. The costs in this example are average costs.

TABLE 2

| | Average incident | Average |
|---|---|---|
| n | cost Iₙ | workaround cost Wₙ |
| 1 | 1000 | 100 |
| 2 | 300 | 200 |
| 3 | 200 | 150 |
| 4 | 1500 | 500 |
| 5 | 900 | 450 |
| 6 | 3000 | 1000 |

In this exemplary embodiment, a number V_{n,p} of occurrences of each n problem for each priority p is given in Table 3 below. In this example there are 6 problems and 4 priorities.

TABLE 3

| n | V_{n,1} | V_{n,2} | V_{n,3} | V_{n,4} |
|---|---|---|---|---|
| 1 | 1 | 3 | 8 | 20 |
| 2 | 0 | 2 | 4 | 8 |
| 3 | 2 | 4 | 6 | 8 |
| 4 | 0 | 2 | 5 | 10 |
| 5 | 1 | 3 | 8 | 30 |
| 6 | 1 | 1 | 4 | 10 |

In this exemplary embodiment, the expected resolution costs C_{n,p} for all 6 problems and all 4 priorities are shown in Table 4 below.

TABLE 4

| n | C_{n,1} | C_{n,2} | C_{n,3} | C_{n,4} |
|---|---|---|---|---|
| 1 | 5000 | 5000 | 5000 | 5000 |
| 2 | 8000 | 5000 | 5000 | 5000 |
| 3 | 2000 | 2000 | 2000 | 2000 |
| 4 | 10000 | 10000 | 10000 | 10000 |
| 5 | 5000 | 5000 | 5000 | 5000 |
| 6 | 25000 | 20000 | 18000 | 18000 |

Using the data in Tables 1-4 of this exemplary embodiment, a cost for fixing problem 1 given a priority of 3 (e.g. dₚ=2 weeks) is:

R_{1,3}=8*(1000+100)+5000=$13,800

Using the data in Tables 1-4 of this exemplary embodiment, a cost for fixing problem 2 given a priority of 1 (e.g. dₚ=3 days) is:

R_{2,1}=0*(300+200)+8000=$8,000

Using the data in Tables 1-4 of this exemplary embodiment, a cost for fixing problem 3 given a priority of 4 (e.g. dₚ=1 month) is:

R_{3,4}=8*(200+150)+2000=$4,800

Using the data in Tables 1-4 of this exemplary embodiment, a cost for fixing problem 4 given a priority of 2 (e.g. dₚ=1 week) is:

R_{4,2}=2*(1500+500)+10000=$14,000

Using the data in Tables 1-4 of this exemplary embodiment, a cost for fixing problem 5 given a priority of 3 (e.g. dₚ=2 weeks) is:

R_{5,3}=8*(900+450)+5000=$15,800

Using the data in Tables 1-4 of this exemplary embodiment, a cost for fixing problem 6 given a priority of 1 (e.g. dₚ=3 days) is:

R_{6,1}=1*(3000+1000)+25000=$29,000

In the exemplary embodiment shown above, a total cost Cₜ for fixing all six problems is:

Cₜ=$13,800+8,000+$4,800+$14,000+$15,800 +$29,000

Cₜ=$85,400

The total cost Cₜ for fixing all 6 problems in the above example depends on the priority assigned to each problem. A different total cost Cₜ for fixing all 6 problems may be obtained by changing the priorities given to each of the 6 problems. A minimum total cost Cₜ may be obtained by assigning different combinations of priories to each of the six problems until a minimum cost Cₜ is obtained. This type of optimization problem may be solved using commercial large-scale mathematical programming software for resource optimization. This type of optimization problem may be expressed as follows:

Minimize (sum(1<n<N, 1<p<P)R_{n,p})

N=number of problems P=number of priorities

In the above embodiment, the cost functions (e.g. Iₙ, Wₙ, C_{n,p}, and R_{n,p}) do not necessarily reflect actual monetary value, but rather may measure business impact. Business impact may be driven by or include other factors. For example, customer satisfaction metrics may be used as a cost function. In another example, a cost function may represent the strategic value of one customer compared to other customers.

Assigning all problems to a first priority may not be possible since support organizations may have limited resources. In another exemplary embodiment, the number of problems that may be assigned to each priority may be limited.

In other embodiments, problem formulation may include other types of constraints that model an IT organization. Some of these constraints include constraint on the resources required to resolve a problem, constraint on the IT services that are affected, and constraint on potential collisions with other resources.

For example, human resources that are available may be used as a constraint. In a first embodiment, the amount of work to resolve a problem in terms of human resources may be described as follows: (1) 2 days for a software engineer to develop software changes, (2) 2 days for a test engineer to verify quality assurance, and (3) 1 day for a support engineer to release changes into production. Human resources may be represented by skills that individuals possess.

In another embodiment, a scheduler may utilize, for example, the priority calculated above to optimize the resolution of N problems. For example, a scheduler may arrange the order of problem resolution based on priority, starting with the highest priority followed by the remaining problems in descending order of priority. In another example, a scheduler may arrange the order of problem resolution based first on priority and then on cost, Cₜ, starting with the lowest cost followed by the remaining problems in ascending order of cost.

A scheduler may utilize not only priorities and costs, but may include constraints which exist between human resources required to resolve the problems. A scheduler may also include constraints which exist because of dependencies of other resources such as software and hardware which may be shared between each of the problems.

Skills may be represented by S and for each skill s there is a capacity constraint K_{s,p}. The capacity constraint K_{s,p} may be a function of priority level p and skill s. As a first example, this capacity constraint K_{s,p} may be written as follows:

For all p and s, 1≦p≦P, 1≦s≦S, sum (1≦n≦N, W_{n,s,p})≦K_{s,p}

W_{n,s,p} represents the amount of work from skill s if a problem n is solved with priority p.

In another embodiment, when the number of priorities P becomes high and the associated expected resolution times dₚ become fined grained (e.g. one priority per day), a problem can be seen as a scheduling problem. In this example, additional constraints K_{s,p} may be used (as described above). For example there may be precedence constraints between problems (i.e. one problem may only be solved after a dependent problem is solved). There may also be conflicts between problems (i.e. some problems cannot be resolved at the same time because they require work on the same IT system).

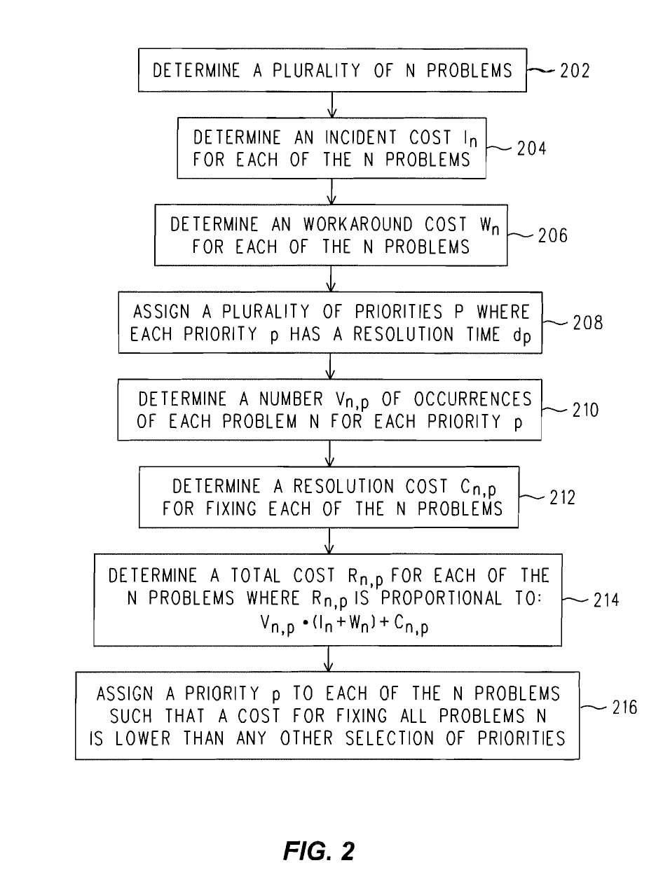

FIG. 2 is a flow chart of an exemplary embodiment of a method of prioritizing problems in IT services. In box 202 a plurality of N problems to be fixed are determined. In box 204 an incident cost Iₙ for each of the N problems to be fixed is determined. In box 206 a workaround cost Wₙ for each of the N problems to be fixed is determined. In box 208 a priority p for each of the N problems is assigned. Each priority p has an expected resolution time dₚ.

In box 210, the number, V_{n,p}, of occurrences of each problem N for each priority p is determined. In box 212, an expected resolution cost C_{n,p} for fixing each of the N problems is determined. In box 214 a total cost R_{n,p} for fixing each of the N problems is determined. In one embodiment, the total cost R_{n,p} for fixing each of the N problems is proportion to:

V_{n,p}*(Iₙ+Wₙ)+C_{n,p}

In box 216 each of the N problems are assigned a priority p such that a total cost Cₜ for fixing all problems N is lower than any other selection of priorities p.

Various computer readable or executable code or electronically executable instructions may be used to create an exemplary embodiment of a method of prioritizing problems in IT services. These may be implemented in any suitable manner, such as software, firmware, hard-wired electronic circuits, or as the programming in a gate array, etc. Software may be programmed in any programming language, such as machine language, assembly language, or high-level languages such as C or C++. The computer programs may be interpreted or compiled.

Computer readable or executable code or electronically executable instructions may be tangibly embodied on any computer-readable storage medium or in any electronic circuitry for use by or in connection with any instruction-executing device, such a general purpose processor, software emulator, application-specific circuit, a circuit made of logic gates, etc. that can access or embody, and execute, the code or instructions.

Methods described and claimed herein may be performed by the execution of computer readable or executable code or electronically executable instructions, tangibly embodied on any computer-readable storage medium or in any electronic circuitry as described above.

A storage medium for tangibly embodying computer readable or executable code or electronically executable instructions includes any means that can store the code or instructions for use by or in connection with the instruction-executing device. For example, the storage medium may include (but is not limited to) any electronic, magnetic, optical, or other storage device. The storage medium may even comprise an electronic circuit, with the code or instructions represented by the design of the electronic circuit. Specific examples include magnetic or optical disks, both fixed and removable, semiconductor memory devices such as a memory card and read-only memories (ROMs), including programmable and erasable ROMs, non-volatile memories (NMMs), optical fibers, etc. Storage media for tangibly embodying code or instructions also include printed media such as computer printouts on paper which may be optically scanned to retrieve the code or instructions, which may in turn be parsed, compiled, assembled, stored and executed by an instruction-executing device.

The foregoing description has been presented for purposes of illustration and description. It is not intended to be exhaustive or to limit the invention to the precise form disclosed, and other modifications and variations may be possible in light of the above teachings. The exemplary embodiments were chosen and described in order to best explain the applicable principles and their practical application to thereby enable others skilled in the art to best utilize various embodiments and various modifications as are suited to the particular use contemplated. It is intended that the appended claims be construed to include other alternative embodiments except insofar as limited by the prior art.

What is claimed is:

1. A method of prioritizing problems in IT services comprising:
determining a plurality of N problems;
determining an incident cost Iₙ for each of the N problems;
determining a workaround cost Wₙ for each of the N problems;
assigning a plurality of P priorities wherein each priority p has an expected resolution time dₚ;
determining a number V_{n,p} of occurrences of each N problem for each priority p;
determining an expected resolution cost, C_{n,p} for fixing each of the N problems;
assigning a priority p from the plurality of P priorities for each of the N problems such that a cost for fixing all N problems is lower than any other selection of priorities from the plurality of P priorities for each of the N problems.

2. The method of claim 1 wherein a total cost R_{n,p} for each of the N problems is proportional to:
V_{n,p}*(Iₙ+Wₚ)+C_{n,p}.

3. The method of claim 1 wherein a first problem from the plurality of N problems is selected from a group consisting of a hardware fault, a configuration error, and a software conflict.

4. The method of claim 1 wherein a first expected resolution time is selected from a group consisting of a service level agreement and historical data.

5. The method of claim 1 wherein a first incident cost is selected from a group consisting of a penalty defined by a service agreement and a loss business.

6. The method of claim 1 wherein the expected resolution cost C_{n,p} for fixing a hardware fault comprises:
a first cost of a hardware engineer to replace faulty hardware with functional hardware;
a second cost of a test engineer to verify that the functional hardware does not create faults;
a third cost of a support engineer to release hardware changes into production.

7. The method of claim 1 wherein the expected resolution cost C_{n,p} for fixing a software conflict includes:
a first cost of a software engineer to write software changes;
a second cost of a test engineer to verify that quality assurance requirements are meet;
a third cost of a support engineer to release the software changes into production.

8. An apparatus for prioritizing problems in IT services comprising:
at least one computer readable medium; and
a computer readable program code stored on said at least one computer readable medium, said computer readable program code comprising instructions for:
storing an incident cost I_{N} for each of N problems;
storing a workaround cost W_{N} for each of the N problems;
storing a plurality of P priorities wherein each priority p has an expected resolution time dₚ;
storing a number V_{N,P} of occurrences of each the N problems for each priority p;
storing an expected cost C_{n,p} for fixing each of the N problems;
assigning a priority from the plurality of P priorities for each of the N problems such that a cost for fixing all N problems is lower than any other assignment of priorities from the plurality of P priorities for each of the N problems.

9. The apparatus of claim 8 further comprising:
calculating a cost R_{n,p} for each of the N problems wherein R_{n,p} is proportional to:
V_{n,p}*(Iₙ+Wₙ)+C_{n,p}

10. A method of scheduling an order of resolution of problems in IT services comprising:
determining a plurality of N problems;
determining an incident cost Iₙ for each of the N problems;
determining a workaround cost Wₙ for each of the N problems;
determining an expected resolution cost, C_{n,p} for fixing each of the N problems;
scheduling an order of resolution for each of the N problems based on the incident cost Iₙ, the workaround cost Wₙ, and the expected resolution cost C_{n,p}.

11. The method of claim 10 wherein the order of resolution for each of the N problems begins with a first problem with the highest total cost Cₜ followed by the remaining problems in descending order of total cost Cₜ.

12. The method of claim 10 wherein the order of resolution for each of the N problems begins with a first problem with lowest total cost Cₜ followed by the remaining problems in ascending order of total cost Cₜ.

13. The method of claim 10 further comprising:
determining constraints which exit between human resources that are required to solve the N problems;
wherein the order of resolution for each of the N problems is further based on the constraints which exit between human resources that are required to solve the N problems.

14. The method of claim 10 further comprising:
determining constraints which exist due to dependencies of other resources between each of the N problems;
wherein the order of resolution for each of the N problems is further based on the constraints which exist due to dependencies of other resources between each of the N problems.

15. The method of claim 14 wherein the other resources are selected from a group consisting of software and hardware.
